(19) United States
(12) Patent Application Publication
(10) Pub. No.: US 2002/0146515 A1
(43) Pub. Date: Oct. 10, 2002

(54) Aqueous compositions for coating metal components

(75) Inventors: Manfred Schwartz, Rosenheim (DE); Bertold Bechert, Gruenstadt (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: BASF Aktiengesellschaft, Ludwigshafen (DE)

(21) Appl. No.: 10/061,151

(22) Filed: Feb. 4, 2002

(30) Foreign Application Priority Data
Feb. 5, 2001 (DE) 10105073.9

(51) Int. Cl. B05D 1/36; B05D 7/00

(52) U.S. Cl. 427/409; 427/407.1; 427/419.1

(57) ABSTRACT

The invention relates to the use of aqueous compositions comprising:

i) at least one aqueous polymer dispersion whose addition polymer P has a glass transition temperature below 0° C. and contains in copolymerized form

from 80 to 99.5% by weight of at least one monoethylenically unsaturated, hydrophobic monomer A,

from 0.5 to 10% by weight of at least one ethylenically unsaturated monocarboxylic or dicarboxylic acid or its anhydride as monomer B, and if desired

from 0 to 10% by weight of one or more ethylenically unsaturated monomers C, different than the monomers A and B, the weight fractions of the monomers A, B and C adding up to 100% by weight,

ii) at least one water-soluble salt or complex salt of an at least divalent metal cation

to produce a basecoat for the coating of metal components.

### DESCRIPTION

The present invention relates to the use of aqueous compositions based on aqueous polymer dispersions as a basecoat for metal components.

Metal components, especially shaped parts of sheet metal, are employed diversely as building materials, for example, as facade elements, as pipelines for incoming and outgoing air, for example, for lining pipelines, as guttering and drainpipes, as window sills, and more recently also as roofing construction elements of sheet metal roofs.

For protection against the effects of weathering, in particular for protecting against corrosion, but also for esthetic reasons, these components are generally provided with a coating. By way of example, components made of ferrous materials have their surfaces galvanized for corrosion protection purposes, giving these components a characteristic appearance. This appearance is not always wanted. Metal parts containing copper, in turn, form a characteristic patina under the effect of weathering, although this patina is not desirable for every application. In the case of roofing construction elements made of metal, moreover, a defined coloring is required, examples being the red, brown or black shades typical of roofing systems.

In the course of the assembly and working of metal components, especially of sheet metal, they are frequently subjected to severe mechanical forces, for example, when being screwed, drilled, nailed or riveted, or when the prefabricated, coated components are being adapted to the local circumstances of the construction, e.g., by being bent, folded, or cut to size. Such operations lead to local, severe, and in some cases sudden, deformations of the component. The coating is required to tolerate these stresses without being damaged.

In many instances, construction elements made from sheet metal are produced by means of the coil coating process. Coil coating imposes particularly stringent requirements on the coating used, since, after coating, the construction elements are shaped by pressing, by drawing for example, and/or are wound up again or cut to size.

These forms of stressing, especially the sudden loading involved in nailing, cutting, drilling, riveting, or bending, often leads to detachment of the coating (delamination) from the surface of the component, i.e., to lifting, flaking or splintering of the coating, especially in the severely loaded regions. This is of course undesirable, since as a result of the damage to the coating both the protective and esthetic functions of the coating are lost. When components are being put in place on site, these problems occur particularly when the ambient temperatures are low, e.g., at temperatures below 10° C. and especially below 5° C.

Moreover, the coatings should be stable to the effects of weathering; in particular, they should not yellow, pick up dirt, or blush.

For construction elements made of metal, the prior art describes coating compositions based on thermosettable polyester resins. These are generally expensive. Moreover, it is generally necessary to bake these resin formulations following application at temperatures from 180 to 260° C. for a relatively long period of time in order to achieve effective adhesion of the coating to the metal surface. For particularly high-quality coatings, coating and baking must in some cases be repeated a number of times. Disadvantages of this process are the long period of the baking operation that is required for sufficient solidification, and the high baking temperatures, which, together with the high costs of the materials employed, make these coatings suitable only for high-grade metal components. The generally high solvent content of these coating compositions is another disadvantage.

An important class of low-solvent coating systems is based on aqueous polymer dispersions (see R. Kuropka in D. Distler (ed.), “Wässrige Polymerdispersionen”, Wiley-VCH 1999, pp. 99-124). Coating compositions of this kind are generally employed with substrates made of wood, paper, stone or concrete. These coating compositions frequently exhibit moderate or poor adhesion to metal and therefore generally fail to meet the abovementioned requirements imposed on coatings for metal components.

The earlier German patent application P 19951068.7 describes the use of aqueous polymer dispersions containing from 0.1 to 5% by weight of organosilicon monomers in copolymerized form as binders for coating compositions which are applied as a basecoat in the preparation of “wet-on-wet” coatings. In principle, the coatings thus obtained exhibit good adhesion to metal surfaces. A problem, however, is the assembly of the metal components at low ambient temperatures, since this is frequently accompanied by flaking of the coating at those areas subjected to mechanical loads.

It is an object of the present invention to provide a coating system suitable for coating metal components, especially metal sheets.

We have found that this object is achieved, and that, surprisingly, coatings adhere particularly well to metal components, when the metal component in question is first coated with a first aqueous composition comprising

i) at least one aqueous polymer dispersion whose addition polymer P has a glass transition temperature below 0° C. and contains in copolymerized form

from 80 to 99.5% by weight of at least one monoethylenically unsaturated, hydrophobic monomer A,

from 0.5 to 10% by weight of at least one ethylenically unsaturated monocarboxylic or dicarboxylic acid or its anhydride as monomer B, and if desired

from 0 to 10% by weight of one or more ethylenically unsaturated monomers C, different than the monomers A and B, the weight fractions of the monomers A, B and C adding up to 100% by weight,

ii) at least one divalent metal cation in water-soluble form.

The present invention accordingly provides for the use of such compositions to prepare a basecoat on the surfaces of metal components.

The present invention also provides a process for coating metal components in which first of all the above-defined aqueous coating composition is applied to the target surface of the metal component in order to provide a basecoat on the surface of the metal component. Then at least one further coating composition is applied to the surface provided with the basecoat. It is well understood by a skilled person that the process also requires the drying or curing of the coating obtained after any further coating composition has been applied. In one embodiment of the invention the basecoat is dried before any further coating composition is applied. In another preferred embodiment the basecoat is not dried or dried only partially before any further coating composition is applied.

The aqueous compositions employed in accordance with the invention are known in part from DE-A 3930585 and DE-A 3800984.

The addition polymer they include contains preferably from 90 to 99 and in particular from 95 to 99% by weight of monomers A in copolymerized form. The fraction of monomers B is preferably from 1 to 10% by weight and in particular from 1 to 5% by weight.

The monomers A are hydrophobic, i.e., they have a low water-solubility, which is generally less than 50 g/l and preferably less than 20 g/l at 25° C. Monomers of this kind are commonly used in emulsion polymerization and are well known to the skilled worker. Examples of suitable monomers A are monovinylaromatics, esters of α, β-ethylenically unsaturated C₃-C₆ monocarboxylic acids with C₁-C₁₈ alkanols or C₅-C₁₀ cycloalkanols, and the vinyl and allyl esters of aliphatic C₂-C₁₈ carboxylic acids.

Examples of monovinylaromatics are styrene, α-methylstyrene, α-phenylstyrene, o-chlorostyrene and vinyltoluenes. Examples of esters of α, β-ethylenically unsaturated C₃-C₆ monocarboxylic acids are, for example, the esters of acrylic acid and the esters of methacrylic acid with C₁-C₁₈, preferably C₁-C₁₀ alkanols, or C₅-C₁₀ cycloalkanols, e.g., methyl acrylate, methyl methacrylate, ethyl acrylate, ethyl methacrylate, n-butyl acrylate, n-butyl methacrylate, isobutyl acrylate, isobutyl methacrylate, tert-butyl acrylate, tert-butyl methacrylate, hexyl acrylate, hexyl methacrylate, n-octyl acrylate, n-octyl methacrylate, 2-ethylhexyl acrylate, 2-ethylhexyl methacrylate, isobornyl acrylate, isobornyl methacrylate, norbornyl acrylate, norbornyl methacrylate, 4-tert-butylcyclohexyl acrylate and 4-tert-butylcyclohexyl methacrylate. Examples of vinyl and allyl esters of aliphatic C₂-C₁₈ carboxylic acids are esters of acetic acid, propionic acid, butyric acid, valeric acid, pivalic acid, hexanoic acid, decanoic acid, lauric acid, and stearic acid, and the monomers available commercially under the designations VEOVA® 5-11 (VEOVA® X is a trade name of Shell and stands for vinyl esters of α-branched, aliphatic carboxylic acids having X carbon atoms, also designated Versatic® X acids).

Preferred monomers A are monovinylaromatic monomers, especially styrene, α-methylstyrene and o-chlorostyrene, with particular preference styrene, esters of acrylic acid of C₂-C₈ alkanols, preferably ethyl acrylate, n-butyl acrylate and 2-ethylhexyl acrylate, with particular preference n-butyl acrylate, and esters of methacrylic acid with C₁-C₄ alkanols, preferably methyl methacrylate, ethyl methacrylate, n-butyl methacrylate, isobutyl methacrylate and tert-butyl methacrylate, with particular preference methyl methacrylate.

It is preferred to use film-forming copolymers whose monomers A include at least one monomer A1, selected from vinylaromatic monomers and the C₁-C₄ alkyl esters of methacrylic acid, especially from styrene and methyl methacrylate, and at least one second monomer A2, selected from the C₂-C₁₀ alkyl esters of acrylic acid, especially from ethyl acrylate, n-butyl acrylate and 2-ethylhexyl acrylate. Preferred monomers A1 are the vinylaromatic monomers. The weight ratio of the monomers A1 to the monomers A2 is preferably in the range from 1:20 to 1:2 and in particular in the range from 1:10 to 1:3.

Monomers B are preferably selected from α, β-ethylenically unsaturated C₃-C₆ monocarboxylic and C₄-C₈ dicarboxylic acids, and their salts. Examples of such monomers B are crotonic acid, acryloyloxyglycolic acid, methacrylamidoglycolic acid, maleic acid, fumaric acid, itaconic acid and citraconic acid, and the anhydrides of these dicarboxylic acids. Particular preference is given to acrylic acid and methacrylic acid.

Monomers C include in principle all monomers that are different than the monomers A and B but copolymerizable with them, the fraction of polyethylenically unsaturated monomers being preferably less than 0.5% by weight, in particular less than 0.1% by weight, and more particularly 0% by weight of the overall monomer amount.

Preferred monomers C are the N-substituted or unsubstituted amides of the aforementioned monocarboxylic and dicarboxylic acids, especially acrylamide and methacrylamide, the hydroxyalkyl esters of the aforementioned ethylenically unsaturated monocarboxylic and dicarboxylic acids, e.g., hydroxyethyl acrylate, hydroxypropyl acrylate, and 4-hydroxybutyl acrylate, and also the corresponding hydroxyalkyl methacrylates. Also suitable are water-soluble N-vinyllactams, e.g. N-vinylpyrrolidone, ethylenically unsaturated nitriles such as acrylonitrile and methacrylonitrile, and also monomers containing urea and/or imidazolidinone groups, such as N-vinylurea, N-acrylamidoethylimidazolidin-2-one, N-methacrylamidoethylimidazolidin-2-one, and monomers containing siloxane groups, such as vinyltrimethoxysilane, vinyltriethoxysilane, vinyldimethoxysilanol, vinyldiethoxysilanol, allyltriethoxysilane, allyltripropoxysilane, acryloyloxyethyltrimethoxysilane, acryloyloxypropyltrimethoxysilane, methacryloyloxyethyltrimethoxysilane, and methacryloyloxypropyltrimethoxysilane. As a fraction of the overall monomer amount, the fraction of the monomers C is generally not more than 10% by weight. The fraction of amides, hydroxyalkyl esters and/or monomers B which carry urea and/or imidazolidinone groups is, where desired, in the range from 0.1 to 10% by weight and in particular in the range from 0.5 to 5% by weight. The fraction of monomers containing siloxane groups is generally, where desired, in the range from 0.1 to 5% by weight, in particular in the range from 0.2 to 2% by weight.

The glass transition temperature of the addition polymers P present in the formulations of the invention will preferably not exceed a level of −10° C. and is situated in particular in the range from −40° C. to −10° C., and with particular preference in the range from −30° C. to −10° C.

In the case of compositions containing different addition polymers with different glass transition temperatures, it is generally advantageous for at least the major amount and in particular at least 80% by weight of the addition polymers to have a glass transition temperature T_{g} within these ranges. Such formulations are, for example, mixtures of two or more different addition copolymers or staged addition polymers, i.e., addition polymers whose particles have a multiphase construction, e.g., a core/shell construction.

The glass transition temperature T_{g} referred to here is the midpoint temperature determined in accordance with ASTM D 3418-82 by differential thermoanalysis (DSC) (cf. Ullmann's Encyclopedia of Industrial Chemistry, 5th Edition, Volume A 21, VCH Weinheim 1992, p. 169 and also Zosel, Farbe und Lack 82 (1976) pp. 125-134; see also DIN 53765).

The glass transition temperature T_{g} may be adjusted to a desired level both by selecting the appropriate monomers and by selecting the proportions of the monomers used in the addition copolymer or copolymers.

In this context it proves useful to estimate the glass transition temperature T_{g} of the copolymer P. According to Fox (T. G. Fox, Bull. Am. Phys. Soc. (Ser. II) 1, 123 [1956] and Ullmanns Enzyklopädie der technischen Chemie, Weinheim (1980), pp. 17-18), the glass transition temperature of copolymers at low levels of crosslinking and high molecular masses is given in good approximation by

$$\frac{1}{{T}_{g}} = \frac{{X}^{1}}{{T}_{g}^{1}} + \frac{{X}^{2}}{{T}_{g}^{2}} + … \frac{{X}^{n}}{{T}_{g}^{n}}$$

where X¹, X², . . . , Xⁿ denote the mass fractions of the monomers 1, 2, . . . , n and T_{g} ¹, T_{g} ², . . . , T_{g} ⁿ denote the glass transition temperatures of the homopolymers of each of the monomers 1, 2, . . . , n, in degrees Kelvin. The latter are known, for example, from Ullmann's Encyclopedia of Industrial Chemistry, VCH, Weinheim, Vol. A 21 (1992) p. 169 or from J. Brandrup, E. H. Immergut, Polymer Handbook 3rd ed., J. Wiley, New York 1989.

It has proven advantageous for the particles of the addition polymer P to have average sizes in the range from 50 to 1 000 nm, in particular from 50 to 500 nm, with particular preference from 60 to 300 nm. By average particle sizes are meant here the volume- and/or weight-average sizes as obtained by measurement with the ultracentrifuge or by light scattering in accordance with known techniques. Methods of adjusting the polymer particle size are known, for example, from EP-A-126 699, EP-A-567 881, EP-A-567 819, DE-A-31 47 008 and DE-A-42 13 967.

The compositions used in accordance with the invention further comprise at least one at least divalent, e.g., divalent, trivalent or tetravalent, metal cation in the form of a water-soluble salt or complex salt. Accordingly, the polyvalent metal cation has a charge number of at least 2, e.g., from 2 to 4. Examples of such metal cations are alkaline earth metal cations such as Mg²⁺, Ca²⁺, Sr²⁺, or Ba²⁺, and also Al³⁺, Zn²⁺, Sn²⁺, Co²⁺, Pb²⁺, Ni²⁺, Cu²⁺, Mn²⁺, Cr³⁺, Ti⁴⁺and/or TiO²⁺, Zr⁴⁺and/or ZrO²⁺, V³⁺, VO³⁺, VO²⁺. Preference is given to cations of alkaline earth metals and especially calcium and also zinc, in each case in water-soluble form, i.e., in the form of a water-soluble salt or complex salt or in the form of a mixture of a salt which may be of low solubility and a suitable solubilizing ligand (complexing agent).

By “water-soluble” is meant here that the substance being used, i.e., the salt or complex salt containing the metal ion, has a solubility in the aqueous phase of the composition or in the aqueous dispersion of the polymer P, where appropriate in the presence of a solubilizing ligand (complexing agents), which is sufficient for the desired amount for use to be dissolved in the composition substantially completely, i.e., without residue.

Examples of suitable salts are the salts of organic or inorganic acids, such as the sulfates, sulfites, nitrates, chlorides, bromides, formates, acetates, and also soluble oxides or hydroxides. Where the salts are to be incorporated into an acidic dispersion, it is of course also possible to use basic salts of low solubility which, as is known, are converted by acids into a water-soluble form, examples being oxides or hydroxides of relatively low solubility. If desired, complexing agents (solubilizing ligands) are added to the salts in order to improve their solubility, examples being alkali metal salts of oxalic acid, of tartaric acid, of citric acid, of ethylenediaminetetraacetic acid, of nitrilotriacetic acid, of pyrophosphoric acids, or of amino acids or amino acid derivatives such as alanine, glycine, valine, norvaline, leucine, norleucine, N-methyl- and N-ethylaminoacetic acid, N-phenylaminoacetic acid, nicotinic acid and, with very particular preference, ammonia.

Examples of suitable salts are magnesium oxide, magnesium hydroxide, magnesium chloride, magnesium acetate, calcium acetate, calcium chloride, calcium hydroxide, strontium hydroxide, barium hydroxide, lead(II) acetate, titanium(IV) oxide diacetate (titanyl acetate), zirconyl acetate, aluminum sulfate, aluminum acetate and aluminum hydroxide. Cations of higher valency, i.e., trivalent or tetravalent cations, will frequently also be used as chelate complexes, e.g., as acetylacetonates such as Al(III) acetylacetonate, Cr(III) acetylacetonate, Zn(II) acetylacetonate, Ti(IV) tris(acetylacetonate) chloride, or as metal alkoxides, such as tetramethyl orthotitanate or tetraethyl orthotitanate.

Particular preference is given to salts of calcium such as calcium chloride, calcium oxide, calcium hydroxide, calcium acetate, and also to salts of zinc, such as zinc oxide, zinc chloride, zinc hydroxide, and the amine complexes of zinc, as are present, for example, in an ammoniacal solution of zinc ammonium hydrogen carbonate and are preparable, for example, by dissolving ZnO and ammonium hydrogen carbonate in aqueous ammonia, preferably in concentrated or half-concentrated aqueous ammonia solution.

The metal salts and/or complex salts are generally employed in an amount of from 0.1 to 2 charge equivalents, preferably from 0.15 to 1.5 charge equivalents and in particular from 0.2 to 1.2 charge equivalents per mole of carboxyl group in the addition polymer P, a charge number of 2 or 3 respectively being reckoned in the case of TiO²⁺, ZrO²⁺, VO³⁺and VO²⁺. Particularly preferred compositions are those in which the metal cation is present in a virtually equivalent amount based on the carboxyl groups in the addition polymer P; i.e., in the case of divalent cations such as Zn²⁺or Ca²⁺, in an amount of 0.5 mol of metal ion per mole of carboxyl groups.

The incorporation of the metal ions into the aqueous dispersion of the polymer P is generally performed by adding a solution of the metal salt in water or in an appropriate, water-miscible organic solvent, e.g., in a C₁-C₄ alcohol such as methanol or ethanol, or in a water/solvent mixture. They may also be added in the form of a solid or in the form of a suspension in water or an appropriate, water-miscible solvent, in the case of zinc oxide and calcium oxide, for example. The dispersion into which the metal salt is to be incorporated preferably has a pH above 5, in particular above 6, and especially in the range from 7 to 10.

The aqueous dispersions of the addition polymers P that are present in the compositions of the invention are known and in some cases are available commercially, or may be prepared by known methods.

In general they are prepared by free-radical aqueous emulsion polymerization in the presence of surface-active substances such as emulsifiers and/or protective colloids, in accordance with processes known per se. Suitable preparation processes are described in Encyclopedia of Polymer Science and Technology, Vol. 5, Wiley & Sons Inc., N.Y. 1966, p. 847 and also in the above-cited DE-A 3930585 and DE-A 3800984. The possibility of preparing addition polymers with multiphase polymer particles by sequential processes is described, for example, in EP-555 959, EP-308 753 and EP-654 454.

Suitable surface-active substances for the preparation of the addition polymers are known and comprise, in general, customary anionic, cationic and nonionic emulsifiers.

For the performance properties of the composition it has proven advantageous for it to comprise at least one anionic emulsifier, and in particular a mixture of at least one anionic and at least one nonionic emulsifier.

As a result of the preparation process, the compositions employed in accordance with the invention contain the surface-active compounds usually in amounts of from 0.1 to 10% by weight, preferably from 0.5 to 5% by weight, based on the overall amount of addition polymer P.

Examples of suitable anionic emulsifiers are alkali metal salts and ammonium salts of alkyl sulfates (alkyl: C₈-C₁₂), of sulfuric monoesters with ethoxylated alkanols (EO units: 2 to 50, alkyl: C₁₂ to C₁₈), of sulfuric monoesters with ethoxylated alkylphenols (EO units: 2 to 50, alkyl: C₄ to C₁₈), of alkylsulfonic acids (alkyl: C₁₂ to C₁₈), and of alkylarylsulfonic acids (alkyl: C₄ to C₁₈). Examples of suitable nonionic emulsifiers are aliphatic nonionic emulsifiers, examples being ethoxylates of long-chain alcohols (EO units: 3 to 50, alkyl: C₈-C₃₆), and also polyethylene oxide/polypropylene oxide block copolymers. Preference is given to ethoxylates of long-chain alkanols (alkyl: C₁₀-C₂₂, average degree of ethoxylation: 3 to 50) and, of these, particularly preference to those based on oxo alcohols and naturally occurring alcohols, with a linear or branched C₁₂-C₁₈ alkyl radical and a degree of ethoxylation of from 8 to 50.

For the properties of compositions used in accordance with the invention it has proven particularly advantageous for the anionic emulsifiers to include at least one compound of the formula I

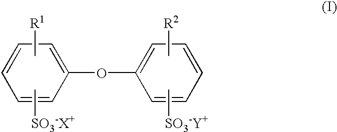

where R¹ and R² independently of one another are hydrogen or a linear or branched alkyl radical having from 4 to 24 carbon atoms and are not both simultaneously hydrogen, and X⁺and Y⁺are identical or different and are a monovalent cation or one cation equivalent. Preferably X⁺and Y⁺in formula I are alkali metal cations and/or ammonium ions, and in particular are a sodium cation. R¹ and R² are preferably linear or branched alkyl radicals having from 10 to 18 carbon atoms, or hydrogen. The compounds of the formula I are known, from EP-A-469 295, for example. Frequently, use is made of technical-grade mixtures containing a fraction of from 50 to 90% by weight of the monoalkylated product, an example being DOWFAX® 2Al(trademark of Dow Chemical Company). Preference is also given to mixtures of compounds of the formula I with further anionic emulsifiers. With particular preference, a compound of the formula I is the sole anionic emulsifier.

In one embodiment of the invention, the compositions employed in accordance with the invention comprise not only the addition polymer P and the at least one metal ion in water-soluble form but also, as constituent iii), at least one inorganic filler, or at least one, preferably inorganic, pigment, or a pigment/filler mixture. The overall amount of filler and pigment is generally such that the composition contains from 5 to 300 parts by weight, preferably from 10 to 200 parts by weight, of pigment plus filler per 100 parts by weight of addition polymer P. In another embodiment, the compositions contain no filler and no pigment. It is of course also possible to formulate the compositions without filler but with pigment. The pigment fraction determines the perceived color of the coating and in the case of pigmented compositions is generally from 5 to 50 parts by weight of pigment to 100 parts by weight of addition polymer P.

The amount of fillers and pigments in the composition is frequently also described by means of the pigment volume concentration, PVC. The pigment volume concentration is the ratio, multiplied by 100, formed from the sum of pigment volume plus filler volume, divided by the overall volume of pigment, filler, and film-forming constituents (in this case addition polymer P). Normally, the pigment volume concentration of the polymer formulations of the invention is in the range from 0 to 50. For reasons of cost it is advantageous to use the compositions in pigmented/filled form. In the aqueous formulations used in accordance with the invention the pigment volume concentration is preferably in the range from 1 to 50, e.g., in the region of approximately 4, approximately 10, approximately 27, or approximately 45.

The fraction of addition polymer P in the compositions of the invention is generally from 10 to 50% by weight, preferably from 35 to 45% by weight, based on the overall weight of the composition. The overall solids content is generally from 30 to 70% by weight, and in pigmented/filled formulations the fraction of component iii) in the composition, depending on the desired PVC, is in the range from 2 to 60% by weight.

Based on the overall weight of the solids present in them, the compositions typically include:

i) from 20 to 90% by weight of addition polymer P,

ii) from 0.1 to 5% by weight of metal ions

iii)from 0 to 25% by weight, e.g. from 2 to 25% by weight, of at least one pigment and/or from 0 to 60% by weight, e.g. from 10 to 60% by weight, of at least one filler, the total amount of pigment +filler generally not exceeding an overall amount of 75% by weight, and

iv) from 0.1 to 20% by weight, preferably from 0.5 to 10% by weight, of customary auxiliaries.

Suitable pigments include in principle all those appropriate for incorporation into aqueous polymer dispersions, the nature of the pigment used typically being guided by the desired color. Typical pigments are inorganic white pigments such as titanium dioxide, preferably in the rutile form. The formulations frequently include color pigments, based preferably on iron oxides, carbon black or graphite, ultramarine, manganese black, antimony black, manganese violet, Paris blue or Schweinfurt green.

Examples of suitable fillers are aluminosilicates, such as feldspars, silicates, such as kaolin, talc, mica, magnesite, preferably alkaline earth metal carbonates, such as calcium carbonate, in the form for example of calcite or chalk, magnesium carbonate, dolomite, alkaline earth metal sulfates, such as calcium sulfate, silicon dioxide, etc. The fillers may be used as individual components.

Besides the emulsifiers used in the polymerization, the customary auxiliaries include wetting agents or dispersants, such as sodium, potassium or ammonium polyphosphates, alkali metal salts and ammonium salts of polyacrylic acids and of polymaleic acid, polyphosphonates, such as sodium 1-hydroxyethane-1,1-di-phosphonate, and also naphthalenesulfonic salts, especially the sodium salts thereof. The dispersants are generally used in an amount of from 0.1 to 0.6% by weight, based on the overall weight of the aqueous formulation.

Additionally, the auxiliaries may further include thickeners, examples being cellulose derivatives, such as methylcellulose, hydroxyethylcellulose and carboxymethylcellulose, and also casein, gum arabic, tragacanth gum, starch, sodium alginate, polyvinyl alcohol, polyvinylpyrrolidone, sodium polyacrylates, water-soluble copolymers based on acrylic and methacrylic acids, such as acrylic acid-acrylamide and methacrylic acid-acrylate copolymers, and what are known as associative thickeners, examples being styrene-maleic anhydride polymers, styrene-acrylic acid-butyl acrylate terpolymers, or hydrophobically modified polyether urethanes.

Inorganic thickeners as well, such as bentonites or hectorite, for example, may be used.

The amount of the thickeners depends on the desired processing viscosity of the composition. For customary coating operations it has been found appropriate for the processing viscosity to be situated within the range from 2 000 to 10 000 mPa.s, and in particular in the range from 3 000 to 6 000 mPa.s, determined as the Brookfield viscosity (spindle 5, 20 rpm, 25° C.). In general, the thickeners, where necessary, are used in amounts of from 0.1 to 3% by weight, preferably from 0.1 to 1% by weight, based on the overall weight of the aqueous formulation.

Furthermore, the auxiliaries generally include defoamers, preservatives or water repellents, biocides, or further constituents.

The compositions of the invention may further comprise from 0.1 to 5% by weight of photosensitive initiators. These have the function of bringing about crosslinking reactions in the surface of the coating. Suitable photoinitiators are described, for example, in EP-A 010000, DE-A 4318083 or EP-A 624610. Suitable photoinitiators contain a group capable of absorbing a part of sunlight. The photoinitiator may be added to the binder, as an additive, either in the form of a photosensitive compound or in the form of a photosensitive oligomer or polymer. It is likewise possible to attach the photosensitive group chemically to the polymer, by copolymerization, for example.

Preferred photoinitiators are benzophenone derivatives in which, if appropriate, one or both phenyl rings are substituted, by for example C₁-C₄ alkyl, hydroxyl, chloro, carboxy-C₁-C₄ alkyl, nitro, amino, etc. Examples of suitable benzophenone derivatives include 4-methylbenzophenone, 4-hydroxybenzophenone, 4-aminobenzophenone, 4-chlorobenzophenone, 4-carboxybenzophenone, 4, 4′-dimethylbenzophenone, 4, 4′-dichlorobenzophenone, 4-carboxymethylbenzophenone, and 3-nitrobenzophenone. Likewise suitable are substituted phenyl ketones, e.g., substituted phenylacetophenones and the like. Benzophenone or 4-substituted benzophenone is particularly preferred.

The addition polymer P may further comprise copolymerized photoinitiators in the abovementioned amounts. In this case the addition polymer P is obtained by copolymerization with monomers containing photosensitive groups. Monomers containing photosensitive groups are disclosed, for example, in US-A 3,429,852, US-A 3,574,617, US-A 4,148,987, and the above-cited DE-A 3930585. They are compounds containing a photosensitive moiety, derived preferably from benzophenone or substituted benzophenone, and attached to it, but preferably not arranged in conjugation with the photosensitive moiety, an olefinic double bond, in the form for example of an allyl, (meth)acrylate or (meth)acrylamide group. Examples of such compounds include allyl benzoylbenzoates or vinyl benzoylbenzoates. Preference is given to vinylbenzylmethyl benzoylbenzoate, hydroxymethacryloyloxypropylmethyl benzoylbenzoate, hydroxymethacryloyloxypropyl benzoylbenzoate and hydroxymethacryloyloxypropoxybenzophenone.

The invention further provides a method of coating metal components, in which a first step comprises applying one of the above-defined aqueous compositions as a basecoat to the target surface of the component and then applying at least one further coating composition to the primer-coated surface.

In the method of the invention, the first coating composition is generally applied in an amount of from 50 to 500 g/m², preferably in an amount of from 100 to 400 g/m², calculated as the dry coating. The application rate of the composition used for the second coating is generally so chosen so as to give a coat thickness in the range from 20 to 500 g/m², preferably from 50 to 250 g/m².

The first composition is generally applied by spraying, knife coating, flow coating, brushing or rolling. The second polymer formulation is generally applied in the same way.

Following the application of the basecoat and before the application of the further coating composition, a drying step may be provided in the course of which the first coating composition is dried completely or almost completely, i.e., to a residual moisture content of less than 5% by weight, based on the overall weight of the dry coating. Drying generally takes place at ambient temperature or at elevated temperature, which may be, for example, from 30° C. to 200° C. The drying time in that case is generally in the range from a few minutes to 48 h, preferably from 10 to 240 minutes, with the drying time and temperature being mutually dependent in a known way, so that the skilled worker is readily able to set the desired degree of drying by way of the time and temperature.

In another embodiment of the method of the invention, the second and/or further coating is applied in accordance with a technique known as the wet-on-wet technique.

The term “wet-on-wet technique” refers generally to a coating technique in which first of all a first fluid, preferably aqueous coating composition is applied to the metal surface that is to be coated and then a second coating composition is applied to the surface which has been provided with the first coating, this second application taking place before the first coating has reached its ultimate strength. A measure of the ultimate strength in the method of the invention is the water content of the first composition applied, which in general should be at least 5% by weight, preferably at least 10% by weight, and with particular preference at least 15% by weight, based on the dry coating, before the second or further coating composition is applied. of course, the second composition may be applied either directly following the application of the first composition or after a drying step conducted in order to reduce the residual moisture content. A kind of partial drying and/or thermal conditioning may be achieved, for example, by applying the first formulation to a preheated article. Suitable preheating temperatures or temperatures suitable for thermal conditioning are in the range from 30 to 100° C., and depend of course on the processing speed.

In one preferred variant of this wet-on-wet technique, following the application of the basecoat and before the application of the second coat, a solid, non-film-forming, particulate material is applied to the still-wet first coating.

For the purposes of this invention, a particulate material means finely divided, free-flowing or scatterable and substantially water-insoluble, non-film-forming particles. Examples of suitable particulate materials are mineral particles, such as sand, gravel, mineral granules, especially stone chippings, clay particles, chalks or pumice, organic particles, such as wood particles and granules of cork or plastic, and metallic particles, such as metal filings. Mineral and organic particles are preferred. The particulate material generally has an average particle size of more than 0.1 mm, e.g., particle sizes in the range from 0.1 to 3 mm. The particulate material is then bound by the second coat.

Particulate materials are applied, where desired, in general in an amount of from 5 to 750 g/m², in particular from 10 to 500 g/m². Mineral particles and organic particles are applied in particular in an amount of from 10 to 250 g/m².

The particulate material is preferably applied in the form of a suspension or solid, more preferably as a solid. Suitable methods of applying such a particulate material are known to the skilled worker. Application takes place preferably by scattering or pouring or by immersing the article provided with the first formulation in the particulate material. Excess material is then removed by striking, shaking or blowing, for example, before the second coating is applied.

In both embodiments of the method of the invention, it is of course possible to apply a third or further coating(s) to the second coating and indeed to do so after a drying step, if the coating applied previously has virtually or completely reached its ultimate strength, or in accordance with the procedure of the wet-on-wet technique.

The application of the second coating is generally followed by a further drying step, which depending on the drying time may be conducted at ambient temperature or at elevated temperature, e.g. at from 30° C. to 200° C. The drying time in that case is generally in the range from a few minutes to 48 h, e.g., from 10 to 240 minutes. Where radiation-curable compositions are used to produce the second coating, radiation curing by exposure to high-energy radiation such as UV light or electron beams will be carried out instead of or in combination with the drying step.

Suitable second or further coating compositions include aqueous coating compositions based on aqueous polymer dispersions, and also nonaqueous coating systems, e.g., polyester coating materials, polymethyl methacrylate, and radiation-curable coating compositions.

Radiation-curable compositions are known to the skilled worker, for example, from P.K.T. Oldring, “Chemistry and Technology of UV- and EB-Formulations for Coatings and Paints”, Vol. II, SITA Technology, London, 1991, and generally comprise as their principal constituent ethylenically unsaturated prepolymers, e.g., urethane acrylates, polyether acrylates, polyester acrylates, epoxy acrylates, melamine acrylates, mixtures of these prepolymers, or mixtures of the prepolymers with mono- or polyethylenically unsaturated compounds of low molecular mass, known as reactive diluents. Examples of suitable radiation-curable compositions are described by EP-A 894780, whose disclosure content is hereby incorporated by reference.

Examples of suitable polyester coating materials are described, for example, by H. Kittel, Lehrbuch der Lacke and Beschichtungen, vol. 2, 2nd, expanded edition, S. Hitzel Verlag, Stuttgart 1998. As a second formulation it is also possible to apply melted polymethyl methacrylate to the original coating.

In one preferred embodiment of the method of the invention the second coating composition used comprises an aqueous composition whose binder comprises an aqueous dispersion of a polymer P′. Where the second coating is applied by the wet-on-wet technique, it is particularly preferred to employ a composition based on an aqueous dispersion of the addition polymer P′ as second and further coating composition.

Polymer formulations of this kind are known to the skilled worker as waterborne coating compositions. Besides the polymer P′, such polymer formulations include the customary auxiliaries for coating compositions, and also, if desired, comprise pigments and fillers. In general, the polymer of the second formulation differs from the polymer of the first formulation in the glass transition temperature, T_{g}, of the polymer, which is generally above 0° C. and preferably in the range from 10° C. to 80° C., in particular in the range from 20 to 60° C.

Suitable aqueous compositions based on aqueous polymer dispersions are known to the skilled worker. In general, they comprise compositions whose addition polymer P′ likewise contains a high proportion of hydrophobic monomers and a low proportion of hydrophilic monomers and/or what are known as auxiliary monomers. The proportion of auxiliary monomers is preferably below 10% by weight, more preferably below 8% by weight, and with particular preference below 5% by weight, based on the overall weight of all copolymerized monomers.

As hydrophobic monomers the polymers P′ contain the aforementioned monomers A, preferably the monomers A stated as being preferred, and in particular a mixture of monomers A1 and A2, in copolymerized form. The weight ratio of monomers A1 to monomers A2 is preferably above 1:2, in particular in the range from 1:1.9 to 3:1, and especially in the range from 1:1.5 to 3.5:1. Typical auxiliary monomers are the abovementioned monomers B and C. Preferred auxiliary monomers are acrylic acid, methacrylic acid, acrylamide, and methacrylamide.

In one preferred embodiment the addition polymers P′ contain not only the monomers A, B and, where appropriate, C but also from 0.1 to 2% by weight of one or more monomers D, containing at least two nonconjugated, olefinically unsaturated double bonds, and/or from 0.1 to 10% by weight, preferably from 0.5 to 5% by weight, of a crosslinking monomer E containing an olefinic double bond and a reactive functional group selected from aldehyde, keto, anhydride, and epoxide groups.

Examples of monomers D, moreover, are divinylaromatics such as divinylbenzene, divinyl and diallyl esters of aliphatic or aromatic dicarboxylic acids, e.g. diallyl phthalate, divinylurea compounds, such as N,N-divinylurea and N,N′-divinyl-N,N′-ethyleneurea (i.e., N,N′-divinylimidazolidin-2-one). Preferred monomers D are the esters of acrylic acid and of methacrylic acid with linear or branched C₃-C₆ alkenols, such as allyl acrylate, methallyl acrylate, 2-buten-1-yl acrylate, 3-buten-1-yl acrylate, 3-methyl-2-buten-1-yl acrylate, 3-methyl-3-buten-1-yl acrylate, 2-methyl-3-buten-2-yl acrylate, 5-hexen-1-yl acrylate, allyl methacrylate, methallyl methacrylate, 2-buten-1-yl methacrylate, 3-buten-1-yl methacrylate, 3-methyl-2-buten-1-yl methacrylate, 3-methyl-3-buten-1-yl methacrylate, 2-methyl-3-buten-2-yl methacrylate, 5-hexen-1-yl methacrylate, the esters of acrylic acid and of methacrylic acid with cyclic C₅-C₇ alkenols, such as cyclohexenyl acrylate, cyclohexenyl methacrylate, methylcyclohexenyl acrylate and methylcyclohexenyl methacrylate, and the esters of acrylic acid and of methacrylic acid with polycyclic C₇ to C₁₂ alkenols, such as norbornenyl acrylate, tricyclodecenyl acrylate, norbornenyl methacrylate and tricyclodecenyl methacrylate. Preference is given to allyl acrylate, methallyl acrylate, tricyclodecenyl acrylate, allyl methacrylate, methallyl methacrylate, and tricyclodecenyl methacrylate, particular preference to allyl acrylate and allyl methacrylate, and very particular preference to allyl methacrylate; and also the diesters of aliphatic diols having from 3 to 10 carbon atoms or cycloaliphatic diols having from 5 to 16 carbon atoms such as propane-1,3-diol, butane-1,4-diol, hexane-1,6-diol, ethylene glycol, diethylene glycol, triethylene glycol, dipropylene glycol, cyclohexane-1,4-diol, 1,4-bis(2-hydroxyprop-2-yl)cyclohexane or 4,4′-dihydroxycyclohexylpropane with acrylic acid and/or methacrylic acid.

Suitable monomers E are, in particular, glycidyl (meth)acrylate, glycidyl allyl ether, maleic anhydride, itaconic anhydride, methacrylic anhydride, diacetonyl acrylamide, and diacetonyl methacrylamide. Addition polymers P′ containing monomers E in copolymerized form are frequently used together with at least one compound E′ containing at least two NH₂ groups. Compounds E′ are known to the skilled worker. Preferred monomers E′ are the dihydrazides of aliphatic C₃-C₁₂ dicarboxylic acids, especially the dihydrazide of adipic acid. The compounds E′ are commonly used in amounts such that the molar ratio of amino groups of the compound E′ to copolymerized monomers E is in the range from 5:1 to 1:5.

The emulsifiers in the compositions of the addition polymers P′ are subject to the same remarks as made above for the compositions used to prepare the basecoat. In particular, the aqueous compositions of the addition polymer P′ include at least one combination of anionic and nonionic emulsifier, with the anionic emulsifier here again preferably comprising compounds of the formula I or their mixtures with salts, preferably sodium salts of alkyl sulfates or of sulfuric monoesters with ethoxylated alkanols.

Suitable aqueous compositions based on aqueous polymer dispersions are described, for example, in EP-A 469295, DE-A 19514266, DE-A 19749642, DE-A 19845999, EP-A-915071, and DE-A 19810050, hereby expressly incorporated by reference.

Particularly suitable second compositions are those whose polymers P′ contain in copolymerized form, as monoethylenically unsaturated monomers, from 40 to 70% by weight of at least one of the aforementioned monomers Al, in particular a vinylaromatic monomer, especially styrene, and from 30 to 60% by weight of at least one acrylic ester of linear and branched C₁-C₁₀ alkanols, preferably ethyl acrylate, n-butyl acrylate and/or 2-ethylhexyl acrylate. Auxiliary monomers present in copolymerized form comprise from 0.1 to 5% by weight, preferably from 0.5 to 2.5% by weight, of monomers B, especially acrylic acid or methacrylic acid, and, where appropriate, from 0 to 3% by weight, e.g., from 0.1 to 3% by weight, of monomers C, e.g., acrylamide or methacrylamide.

In the case of compositions with low levels of pigmentation, and especially in the case of clearcoat materials, particularly suitable copolymers are those described above in which some or all, especially all, of the vinylaromatic monomers have been replaced by methyl methacrylate. The increased fraction of methyl methacrylate enhances the weathering stability of the coating in the case of formulations with little or no pigmentation. In the case of more highly pigmented compositions, e.g., at a pigment volume concentration ≧20, coatings containing styrene are at least equal in value to those containing methyl methacrylate and are frequently preferred on grounds of cost.

Likewise particularly suitable as the second polymer formulation are aqueous compositions in which the polymers P′ contain in copolymerized form from 70 to 99.9% by weight, in particular from 80 to 99.5% by weight, of at least one methacrylic ester of C₁-C₁₀ alkanols, preferably n-butyl methacrylate, as principal monomer, from 0 to 20% by weight of monomers A different than said principal monomer, and from 0.1 to 10, preferably from 0.5 to 5,% by weight of monomers B and/or C. Such formulations are described in DE 198 10 050, hereby incorporated in its entirety by reference.

Suitable compositions further include those comprising an addition polymer P′ containing in copolymerized form

from 80 to 99.8% by weight, preferably from 90 to 99.8% by weight, of at least one monomer A, selected preferably from esters of acrylic acid with C₁-C₁₂ alkanols, esters of methacrylic acid with C₁-C₈ alkanols, and monovinylaromatics, and especially from ethyl acrylate, n-butyl acrylate, 2-ethylhexyl acrylate, styrene, methyl methacrylate, and n-butyl methacrylate,

from 0.1 to 19.9% by weight of at least one monomer different than A, selected from monomers B and C, preferably from α, β-ethylenically unsaturated C₃-C₆ monocarboxylic and dicarboxylic acids, the amides and N-alkyl amides of these carboxylic acids, particularly from acrylic acid, methacrylic acid, itaconic acid, acrylamide, and methacrylamide,

from 0.1 to 2% by weight of at least one monomer D, selected preferably from esters of acrylic acid or methacrylic acid with linear or branched C₃-C₆ alkenols, cyclic C₅-C₇ alkenols, and polycyclic C₇ to C₁₂ alkenols, and also the diesters of aliphatic or cycloaliphatic diols with acrylic acid and/or methacrylic acid, and, if desired,

from 0 to 5% by weight of a monomer E, preferably a monomer E containing a keto group, and particularly selected from diacetonylacrylamide and diacetonylmethacrylamide,

the overall amount of monomers which carry free acid groups, based on the overall amount of all copolymerized monomers, being less than 5% by weight. Where the addition polymer P′ contains a monomer E in copolymerized form, these compositions may also include a substance E′ in the amounts indicated above. Compositions of this kind are known, for example, from DE 19849555, hereby incorporated in its entirety by reference.

The compositions used for preparing the second and any further coatings may be employed in the form of a clearcoat material, i.e., in the form of a composition free from pigment and filler. Radiation-curable compositions and also compositions based on polyester resins are frequently employed in unpigmented form. Aqueous compositions based on addition polymers P′ may be employed either in filled/pigmented form or in unfilled form, i.e., as clearcoat material. Regarding the filler and pigment content, the comments made above for the first composition apply.

The first and the second compositions may be formulated either with the same or with a different pigment volume concentration. In one preferred embodiment of the method of the invention, the second composition is formulated with a PVC lower by at least 10 PVC units, preferably by at least 20 PVC units, than the PVC of the composition used for the basecoat.

The metal construction elements for coating may consist of any of a very wide variety of metals. In general, the metals concerned are ferrous metals such as steel, nonferrous metals such as copper or brass, aluminum or its alloys, with components made of ferrous metals frequently having galvanized surfaces. The metal components may also have been provided with a primer, based on a baking enamel, for example, based on a polyester coating material as mentioned above. Typically, the metal construction elements are shaped or unshaped metal sheets. Typical metal construction elements were mentioned at the outset. One preferred embodiment of the invention relates to metal roof construction elements. These are components as commonly used to cover roofs, but unlike conventional roof construction elements are manufactured not from clay or concrete but rather from sheet metal, especially sheet steel, which may also have been galvanized or may have a baking enamel coating. Examples of roof construction elements are pantiles, ridge tiles, chimney mantels, gable tiles and ventilation pipes, and also roof window surrounds.

The metal components coated by the method of the invention are novel and likewise provided by the present invention. These metal components, surprisingly, possess better mechanical stability of the coating to mechanical loads during processing, especially at low ambient temperatures. Unlike that which is the case with conventional coatings, flexing of the article or another mechanical load, as occurs, for example, during drilling, hammering, nailing or cutting of the component, does not lead to flaking of the coating. Moreover, the blushing tendency of the coatings is low. Additionally, the coatings are weathering-stable; in other words, on weathering, especially on exposure to UV radiation, there is little if any discoloration or cracking.

### EXAMPLES

I. Aqueous polymer dispersions ED1 and ED2 and also VD1 to VD5 used as binders for the primer

ED1: In accordance with preparation example D1 from DE-A 3930585, an aqueous polymer dispersion was prepared from 50 parts by weight of n-butyl acrylate, 35 ppw of 2-ethylhexyl acrylate, 15 ppw of styrene, 3 ppw of acrylic acid and 1.25 ppw of acrylamide in the presence of 1.5 parts by weight of anionic emulsifier (sodium salt of disulfonated monododecyl diphenyl ether) and 1.0 part by weight of nonionic emulsifier (ethoxylated C₁₆/Cl₁₈ fatty alcohol having an average degree of ethoxylation of 18). Then 10 g of zinc oxide were added in the form of an aqueous solution of 10 g of zinc oxide and 10 g of ammonium hydrogen carbonate in 30 g of 28% strength aqueous ammonia. The solids content of the dispersion was 58% by weight. The glass transition temperature of the addition polymer was −25° C.

ED2: Preparation was carried out as for ED1 but adding 1.4 g of calcium oxide as a 5% by weight slurry instead of the ammoniacal zinc oxide solution. The solids content of the dispersion was 58% by weight. The glass transition temperature of the addition polymer was −25° C.

VD1 to VD5: The preparation took place by free-radical aqueous emulsion polymerization of the monomer composition given in table 1 in the presence of 0.5 part by weight of sodium lauryl sulfate as emulsifier. The dispersions were adjusted to a pH of 8 using ammonia. The monomer composition of the polymers and their glass transition temperatures are given in table 1.

TABLE 1

| | Copolymerized monomers | | | | |
|---|---|---|---|---|---|
| | | n-Butyl | Acrylic | γ-Methacryloyloxy- | |
| | Styrene | acrylate | acid | propyltrimethoxy- | Tg²⁾ |
| Dispersion | [pbw ]¹⁾ | [pbw] | [pbw] | silane [pbw] | [° C.] |
| VD1 | 54 | 44 | 2 | 0.5 | +35 |
| VD2 | 49 | 49 | 2 | 0.5 | +25 |
| VD3 | 49 | 49 | 2 | — | +23 |
| VD4 | 54 | 44 | 2 | — | +32 |
| VD5 | 29 | 69 | 2 | — | −15 |

¹⁾pbw = part(s) by weight
²⁾glass transition temperature determined from elasticity modulus by Zosel method

In addition, a polymer blend was prepared from 50 parts by weight each of dispersions VD3 and VD5.

II. Aqueous dispersions of the addition polymer P′ (dispersions D6 and D7)

a) Preparation Instructions for D6

A polymerization vessel was charged with 627.6 g of deionized water and 69.4 g of emulsifier solution, and this initial charge was heated to 82° C. In a feed vessel 1, an emulsion was prepared from

605.4 g of deionized water

17.3 g of emulsifier solution

1 211.7 g of n-butyl methacrylate

18.2 g of methacrylic acid

18.3 g of butanediol diacrylate

60.8 g of 20% strength aqueous diacetoneacrylamide solution

121.2 g of 20% strength aqueous acrylamide solution.

In a second feed vessel, 2, a solution was prepared of 1.7 g of sodium peroxodisulfate in 68.9 g of water. Then, maintaining the 85° C., 100 g of feed stream 1 and 16.3 g of feed stream 2 were added in succession in one portion to the initial charge. Thereafter, via spatially separate feeds and beginning simultaneously, the remainder of feed stream 1, over the course of 2.5 h, and the remainder of feed stream 2, over the course of 2.6 h, were introduced into the polymerization vessel, while maintaining the 85° C. After the end of feed stream 2, polymerization was continued for 1 h, the reaction mixture was cooled to 60° C. and neutralized with ammonia (pH≈7.5), 148 g of a 12% strength by weight solution of adipic dihydrazide in water were added, stirring was continued at 60° C. for a further 30 minutes, and then the dispersion was cooled to room temperature. Its solids content was about 45% by weight.

Emulsifier solution: 28% strength by weight solution of the sodium salt of a fatty alcohol ether sulfate in water (C₁₂-C₁₄ alkyl, 2.5 ethylene oxide units)

b) Dispersion D7

Emulsion polymer prepared by free-radical emulsion polymerization of 53.5 parts by weight of methyl methacrylate, 45 parts by weight of ethylhexyl acrylate, 1 part by weight of methacrylic acid and 0.5 part by weight of methacrylamide in the presence of 0.5 part by weight of DOWFAX® 2Al(calculated as solids). The dispersion obtained was adjusted to a pH of 8 using sodium hydroxide solution. Its solids content was about 50% by weight. The glass transition temperature T_{g} of the resulting addition polymer was 28° C., determined by means of DSC.

III. Preparation of the coating compositions

All the dispersions were adjusted to solids contents of 50% by weight.

1. Primer composition

The polymer dispersions ED1, ED2 and VD1 to VD5 prepared in I. were formulated to paints with a PVC of 40. For this purpose, 1 000 parts by weight of dispersion VD1-VD5 (50%) were first treated with 5 g of a commercial defoamer (Tego Foamex® 825 from Th. Goldschmidt AG) and 50 g of a technical-grade mixture of di-n-butyl esters of succinic, glutaric and adipic acids. The dispersions ED1 and ED2 were used untreated.

Then, in the presence of small amounts of wetting agents, defoamers, viscosity modifiers and a biocide, 33.6 parts by weight of a commercially customary filler mixture (calcium carbonate/calcium silicate) and 8.7 parts by weight of black iron oxide pigment were suspended in 13.2 parts by weight of water, and 44.5 parts by weight of the treated dispersion or a corresponding amount of ED1 or ED2 were added. The PVC of the paint was about 40.

2. Second coating composition

First of all, 1 000 g each of dispersions D6 and D7 were treated as described under 1. Then 38 g of black iron oxide pigment were suspended in about 30 g of water, and 600 g of treated polymer dispersion were added. This gave a paint 10 having a pigment volume concentration of about 4.

III. Testing of the performance properties

To test the performance properties, the articles employed were galvanized, coil-coated metal sheets. The sheets were preheated to 40° C. and one of the above-described formulations in each case was applied in an amount of 250 g/m². Application was by spraying. Within a period of less than 5 minutes, stone chips with an average particle size of 2 mm were scattered onto the still-wet first formulation, the excess being removed by blowing with compressed air, and in the course of a further 5 minutes a second formulation was applied by spraying at a rate of 100 g/m². The wet-on-wet coated article thus obtained was subsequently dried at from 60 to 65° C. for approximately 45 minutes.

In order to determine the delamination tendency, the coated and dried metal sheets were bent along one edge by about 90° at 5°0 C. The delamination occurring as a result of the mechanical load was assessed visually. Assessment was based on the following scale:

0=no delamination

1=barely perceptible

2=readily perceptible

3=obvious

4=very obvious

5=extremely obvious

TABLE 2
Results of performance testing

| | | Second | |
|---|---|---|---|
| | First composition/ | formulation/ | |
| Example | dispersion | dispersion | Delamination |
| V1 | VD1 | D6 | 4 |
| V2 | VD2 | D6 | 4 |
| V3 | VD3 | D6 | 4 |
| V4 | VD4 | D6 | 4-5 |
| V5 | VD3/VD5 | D6 | 3 |
| B1 | ED1 | D6 | 1 |
| B2 | ED2 | D6 | 1 |
| B3 | ED1 | D7 | 1 |
| B4 | ED2 | D7 | 1 |

The examples show clearly that the use in accordance with the invention of first formulations based on the dispersions ED1 and ED2 as first composition leads to coatings having markedly improved adhesion properties and/or a markedly reduced delamination tendency when metal components are subjected to mechanical stress.

We claim:

1. A method of coating metal components by applying a first coating composition to the target surface of the component as to provide a basecoat and then applying at least one further coating composition to the surface provided with the basecoat, which comprises selecting the first coating composition from aqueous compositions, which comprise:
i) at least one aqueous polymer dispersion whose addition polymer P has a glass transition temperature below 0° C. and contains in copolymerized form
from 80 to 99.5% by weight of at least one monoethylenically unsaturated, hydrophobic monomer A,
from 0.5 to 10% by weight of at least one monoethylenically unsaturated monomer B selected from monocarboxylic acids, dicarboxylic acid and their anhydrides, and if desired
from 0 to 10% by weight of one or more ethylenically unsaturated monomers C, different than the monomers A and B, the weight fractions of the monomers A, B and C adding up to 100% by weight,
ii) at least one water-soluble salt or complex salt of an at least divalent metal cation.

2. The method as claimed in claim 1, wherein said at least divalent cation is selected from Zn²⁺ and Ca²⁺.

3. The method as claimed in claim 1, wherein the molar ratio of carboxyl groups of the monomers B to equivalents of the metal cation in the composition is in the range from 10:1 to 1:10.

4. The method as claimed in claim 1, wherein the monomer A is selected from the C₁-C₁₀ alkyl esters of acrylic acid, the C₁-C₁₀ alkyl esters of methacrylic acid, and vinylaromatic compounds.

5. The method as claimed in claim 1, wherein the monomer B is selected from acrylic acid and methacrylic acid.

6. The method as claimed in claim 1, wherein the first coating composition, based on its overall weight, contains from 10 to 50% by weight of at least one addition polymer P.

7. The method as claimed in claim 1, wherein the first coating composition per 100 parts by weight of addition polymer P contains from 5 to 300 parts by weight of at least one inorganic filler, at least one pigment, or a mixture of at least one inorganic filler and at least one pigment as component iii).

8. The method as claimed in claim 1, wherein the metal component is a shaped part made of sheet metal.

9. The method as claimed in claim 1, wherein the further coating composition is applied to the surface provided with the basecoat before the basecoat has dried.

10. A method as claimed in claim 9, wherein before the basecoat is dried a particulate material having an average particle size of more than 0.1 mm is applied to the wet basecoat.

11. The method as claimed in claim 1, wherein said at least one further coating composition comprises as binder at least one aqueous dispersion of an addition polymer P′.

12. The method as claimed in claim 12, wherein the addition polymer P′ has a glass transition temperature in the range from 10° C. to 80° C.

13. The method as claimed in any of claim 1, wherein the first aqueous composition is applied in an amount of from 50 to 500 g/m², calculated as nonvolatile constituents of the composition.

14. The method as claimed in claim 1, wherein the first aqueous composition comprises:
i) from 20 to 90% by weight of addition polymer P,
ii) from 0.1 to 5% by weight of metal ions
iii) from 2 to 25% by weight of at least one pigment and/or from 10 to 60% by weight of at least one filler, the total amount of pigment+filler not exceeding an overall amount of 75% by weight, and
iv) from 0.1 to 20% by weight, of customary auxiliaries.

15. A coated metal component obtained by a method as claimed in claim 1.
